(19) United States
(12) Patent Application Publication
(10) Pub. No.: US 2025/0088064 A1
(43) Pub. Date: Mar. 13, 2025

(54) STRING TRIMMER

(71) Applicant: Greenworks (Jiangsu) Co., Ltd, Changzhou (CN)

(72) Inventor: Binghui Zhu, Changzhou (CN)

(21) Appl. No.: 18/826,236

(22) Filed: Sep. 6, 2024

(30) Foreign Application Priority Data
Sep. 7, 2023 (CN) 202322440652.4

(51) Int. Cl. H02K 5/10; A01D 34/416; A01D 101/00; H02K 5/20; H02K 7/14; H02K 9/06; H02K 11/00

(52) U.S. Cl. CPC H02K 5/10; A01D 34/416; H02K 5/207; H02K 7/145; H02K 9/06; H02K 11/0094; A01D 2101/00

(57) ABSTRACT

A string trimmer includes a casing, a battery pack, a motor, a volute structure and a metal dust-proof net. The battery pack is assembled on the casing. The motor is accommodated in the casing. The volute structure is assembled in the casing. The metal dust-proof net is mounted on the casing. The volute structure forms a cavity and an air outlet communicating the cavity with an outside. The motor is partially accommodated in the cavity. The air outlet is located at a top of the volute structure and is positioned facing a side wall of the casing. A bottom of the casing is provided with an air inlet, and the metal dust-proof net is mounted at the air inlet.

### CROSS REFERENCE TO RELATED APPLICATION

The present application claims the priority of the following Chinese patent application: serial No. 202322440652.4, filed on Sep. 7, 2023; the disclosure of which is hereby incorporated by reference herein in its entirety for all purposes.

### TECHNICAL FIELD

The disclosure relates to a string trimmer and belongs to a field of garden tools.

### BACKGROUND

As a garden tool, a string trimmer may be operated by users to trim a lawn.

The main string trimmers on the market currently use brushless external rotor motors as their power source. When the machine is working, the motor will generate heat. In order to ensure the duration life of the motor, the heat dissipation of the motor is very important. Currently, the market adopts the method of opening air inlets and outlets on the housing that wraps the motor for motor heat dissipation. However, there are obvious disadvantages. Dust and water droplets may easily enter from the air inlet on the casing and easily damage the motor. The air inlet on the casing also affects the appearance of the machine. At the same time, when the machine is working, the hot air thrown out by the motor fan blades will blow towards the operator, affecting the experience, and the heat dissipation effect of the motor is also poor.

In view of this, it is necessary to improve the conventional string trimmers to solve the problems mentioned above.

### SUMMARY

One or more embodiments of the disclosure provide a string trimmer, the string trimmer has a complete casing appearance, a motor of the string trimmer has better heat dissipation effect, and operator's experience is also better.

One or more embodiments of the disclosure provide the string trimmer. The string trimmer includes a casing, a battery pack, a motor, a volute structure and a metal dust-proof net. The battery pack is assembled on the casing. The motor is accommodated in the casing. The volute structure is assembled in the casing. The metal dust-proof net is mounted on the casing. The volute structure defines a cavity and an air outlet communicating the cavity with an outside. The motor is partially accommodated in the cavity. The air outlet is located at a top of the volute structure and is positioned facing a side wall of the casing. A bottom of the casing is provided with an air inlet, and the metal dust-proof net is mounted at the air inlet.

In an embodiment of the disclosure, an annular volute passage is arranged in the cavity, the volute passage is communicated with the air outlet, the motor is provided with a fan blade, the fan blade is accommodated in the cavity, and the volute passage is arranged around the fan blade.

In an embodiment of the disclosure, the motor is provided with an air inlet hole, the air inlet hole is communicated with the air inlet and the volute passage, so that external airflow enters from the air inlet, passes through the motor via the air inlet hole, enters the volute passage, and then flows out from the air outlet.

In an embodiment of the disclosure, the volute structure includes a first housing and a second housing assembled with each other, the first housing is provided with a protruding part, the protruding part is fixedly connected with the casing, the protruding part is provided with a holding space, and the motor passes through the second housing and enables a motor shaft of the motor to extend into the holding space and to be connected with the protruding part.

In an embodiment of the disclosure, the first housing and the second housing are assembled with each other through a buckle and a concentric hole.

In an embodiment of the disclosure, the casing includes an upper casing and a lower casing, a recess is arranged on a side wall of the lower casing, the volute structure extends to the recess and enables the air outlet to be located above the recess, and the upper casing covers the air outlet.

In an embodiment of the disclosure, the metal dust-proof net includes a frame and a filter net flatly arranged on the frame, the frame is mounted on the casing through a hook and a fastener, and the filter net is limited between the frame and the air inlet.

In an embodiment of the disclosure, a mounting groove is arranged on one side of the casing, and the battery pack is detachably inserted into the mounting groove.

In an embodiment of the disclosure, a guiding rail is arranged on an inner wall of the mounting groove, and a guiding groove is arranged on an outer wall of the battery pack, and the guiding rail and the guiding groove are matched with each other to guide the battery pack to be inserted into the mounting groove.

In an embodiment of the disclosure, the casing is provided with an opening, the opening is communicated with the mounting groove to enable the battery pack to be partially exposed.

Beneficial effects of one or more embodiments of the disclosure are: the string trimmer is provided with the volute structure assembled in the casing and the metal dust-proof net mounted in the casing, the volute structure forms the cavity and the air outlet communicating the cavity with an outside, the motor is partially accommodated in the cavity, the air outlet is located at the top of the volute structure and corresponds to the side wall of the casing, the bottom of the casing is provided with the air inlet, and the metal dust-proof net is mounted at the air inlet. Not only does it enable an appearance of the casing to be more complete, but it also improves a heat dissipation of the motor, while also giving an operator a better experience.

### BRIEF DESCRIPTION OF THE DRAWINGS

FIG. 1 is a perspective schematic structural view of a string trimmer according to at least one embodiment of the disclosure.

FIG. 2 is a schematic internal structural view of the string trimmer in FIG. 1.

FIG. 3 is a schematic structural view of the string trimmer in FIG. 1 from another angle.

FIG. 4 is a cross-sectional view of the string trimmer in FIG. 1.

FIG. 5 is a perspective schematic structural view of a volute structure in FIG. 2.

FIG. 6 is a perspective schematic structural view of the volute structure in FIG. 2 from another angle.

FIG. 7 is a perspective schematic structural view of a motor in FIG. 2.

FIG. 8 is a perspective schematic structural view of a metal dust-proof net in FIG. 2.

### DETAILED DESCRIPTION

In order to enable a purpose, technical solutions and advantages of the disclosure to be clearer, the disclosure is described in detail below with reference to accompanying drawings and specific embodiments.

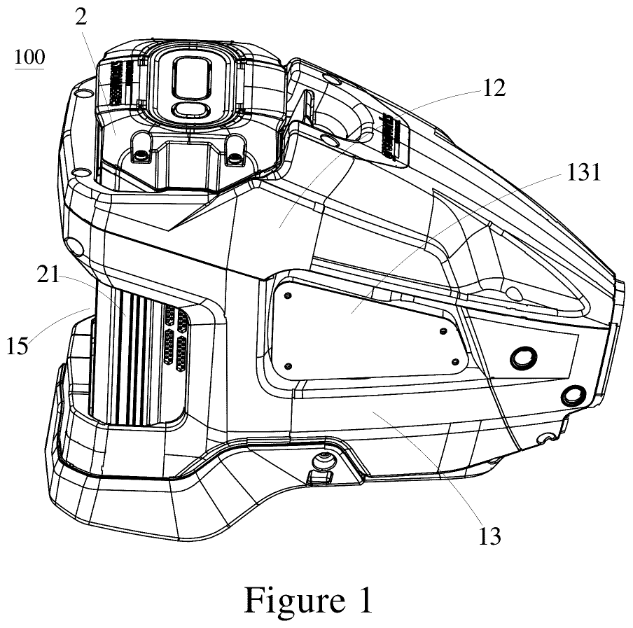

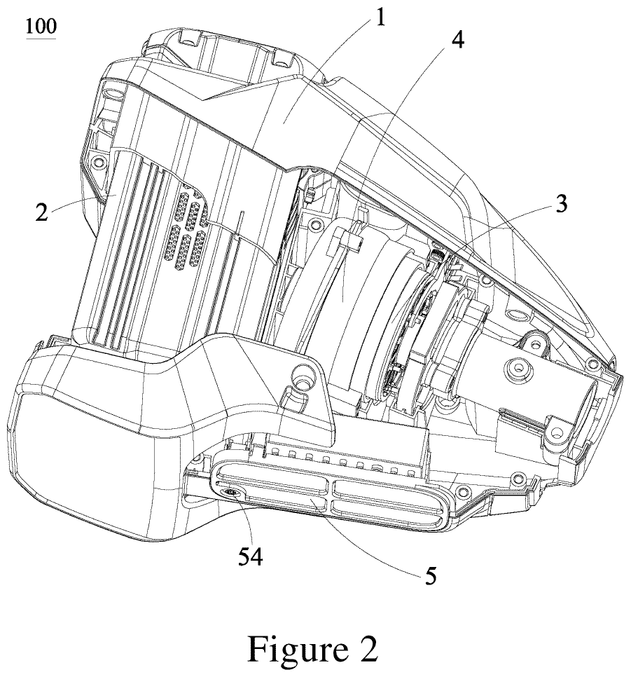

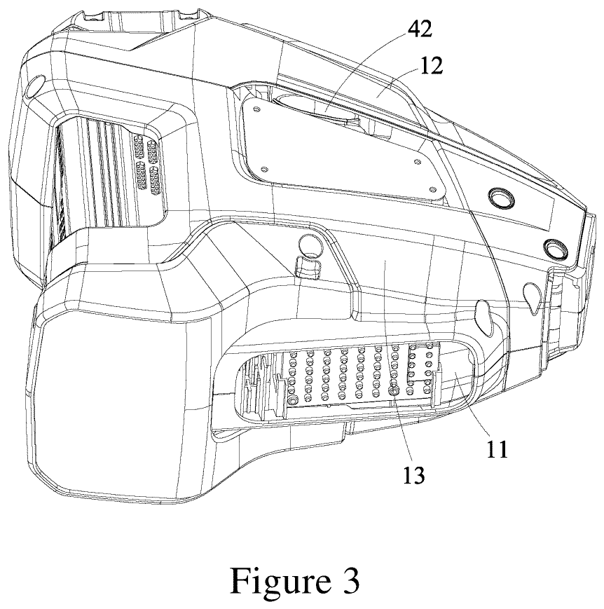

Please refer to FIG. 1 through FIG. 3. The disclosure provides a string trimmer 100. The string trimmer 100 includes a casing 1, a battery pack 2 assembled on the casing 1, a motor 3 accommodated in the casing 1, a volute structure 4 assembled in the casing 1 and a metal dust-proof net 5 mounted on the casing 1. The volute structure 4 enables the motor 3 to have a better heat dissipation effect, and the metal dust-proof net 5 can prevent dust and water droplets from entering an interior of the casing 1, thereby increasing a duration life of the motor 3.

In this embodiment, the volute structure 4 defines a cavity 41 and an air outlet 42 communicating the cavity 41 with an outside. The motor 3 is partially accommodated in the cavity 41. The air outlet 42 is located at a top of the volute structure 4 and is positioned facing a side wall of the casing 1. When the motor 3 is working, generated hot air is discharged from the air outlet 42 and does not blow toward the operator, so that the operator has a better experience. A bottom of the casing 1 is provided with an air inlet 11, and the metal dust-proof net 5 is mounted at the air inlet 11, so that an appearance of the casing 1 is more complete.

In one embodiment, the casing 1 includes an upper casing 12 and a lower casing 13. A plurality of limiting components (not shown) is arranged on an inner wall of the casing 1 to limit the volute structure 4 and the motor 3 inside the casing 1. A recess 131 is arranged on a side wall of the lower casing 13. The volute structure 4 extends to the recess 131 and enables the air outlet 42 to be located above the recess 131. The upper casing 12 covers the air outlet 42. When the hot air is discharged from the air outlet 42, it will be blocked by the upper casing 12 and an air direction will be changed, and then it will be discharged along the lower casing 13, which greatly improves operator's experience.

In this embodiment, a mounting groove (not labeled) is arranged on one side of the casing 1, and the battery pack 2 is detachably inserted into the mounting groove. A guiding rail (not labeled) is arranged on an inner wall of the mounting groove, and a guiding groove 21 is arranged on an outer wall of the battery pack, and the guiding rail and the guiding groove 21 are matched with each other to guide the battery pack to be inserted into the mounting groove. The guiding rail is integrated on the upper casing 12, which may save a part, reduce cost, lighten a weight, and reduce assembly and manufacturing errors. In some embodiments, the casing 1 is provided with an opening 15. The opening 15 is communicated with the mounting groove so that the battery pack 2 is partially exposed, which is also beneficial to reducing a weight of the string trimmer 100 and facilitating the heat dissipation of the battery pack 2 when the string trimmer 100 is working.

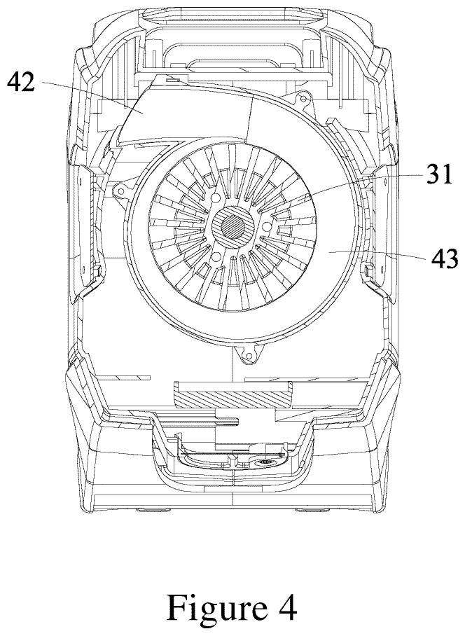

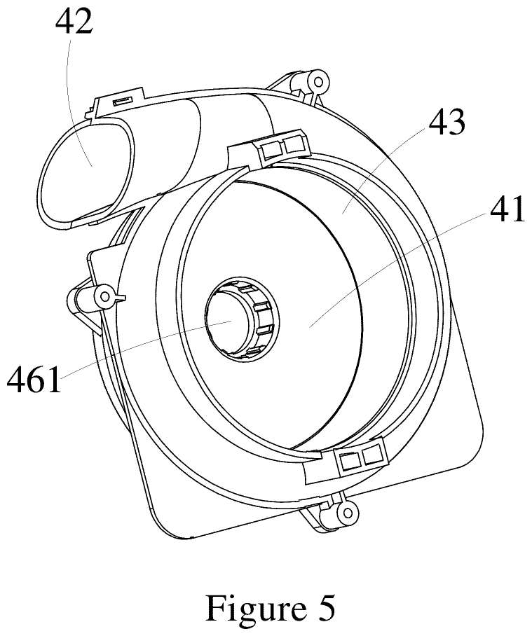

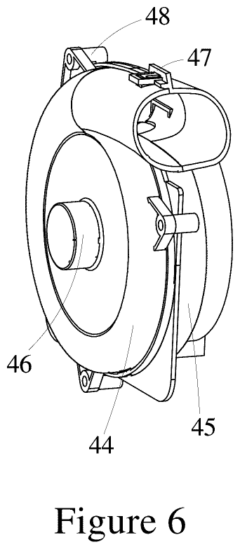

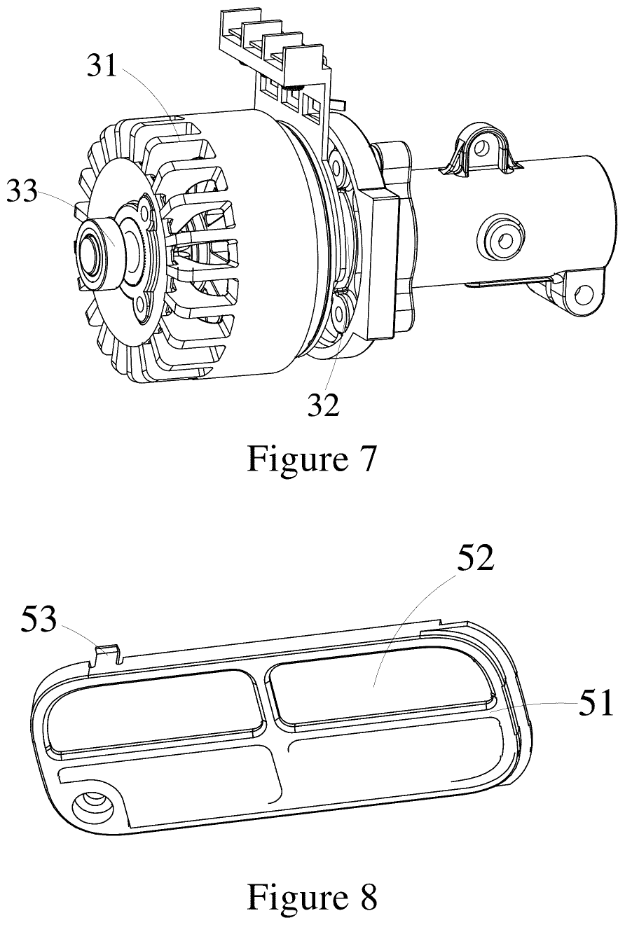

Please refer to FIG. 4 through FIG. 7. The cavity 41 is provided with an annular volute passage 43, and the volute passage 43 is communicated with the air outlet 42. The motor 3 is provided with a fan blade 31, and the fan blade 31 is accommodated in the cavity 41. The volute passage 43 is arranged around the fan blade 31, and the hot air generated by a rotation of the fan blade 31 may be guided through the volute passage 43 and discharged from the air outlet 42. The motor 3 is provided with an air inlet hole 32, and the air inlet hole 32 is communicated with the air inlet 11 and the volute passage 43, so that external air enters from the air inlet 11, passes through the motor 3 via the air inlet hole 32, enters the volute passage 43, and then flows out from the air outlet 42, which takes away the hot air generated by the rotation of the fan blades 31, thereby achieving a heat dissipation effect on the motor 3. Other specific structures of the motor 3 may adopt conventional technical solutions, so they are not described in detail here.

In one embodiment, the volute structure 4 includes a first housing 44 and a second housing 45 assembled with each other, the first housing 44 is provided with a protruding part 46, the protruding part 46 is fixedly connected with the casing 1, the protruding part 46 is provided with a holding space 461, the motor 3 passes through the second housing 45 and enables a motor shaft 33 to extend into the holding space 461 and to be connected with the protruding part 46. The first housing 44 and the second housing 45 are assembled with each other through a buckle 47 and a concentric hole. 48 In this embodiment, the buckle 47 is located at a top of the air outlet 42, and the concentric holes 48 are arranged around an outside of the volute passage 43. There is one buckle 47 and three concentric holes 48 to assemble the first housing 44 and the second housing 45. Of course, numbers and mounting positions of the buckles 47 and the concentric holes 48 may also be in other forms, as long as an assembly and fixation of the first housing 44 and the second housing 45 can be achieved, which are not limited here.

Please refer to FIG. 8. The metal dust-proof net includes a frame 51 and a filter net 52 flatly arranged on the frame 51, the frame 51 is mounted on the casing 1 through a hook 53 and a fastener 54, and the filter net 52 is limited between the frame 51 and the air inlet 11. The fastener 54 may be a part such as a screw that can play a fixing role, which is not limited here.

In summary, the string trimmer 100 of the disclosure is provided with the volute structure 4 assembled in the casing 1 and the metal dust-proof net 5 mounted in the casing 1, the volute structure 4 defines the cavity 41 and the air outlet 42 communicating the cavity 41 with the outside, the motor 3 is partially accommodated in the cavity 41, the air outlet 42 is located at the top of the volute structure 4 and corresponds to the side wall of the casing 1, the bottom of the casing 1 is provided with the air inlet 11, and the metal dust-proof net 5 is mounted at the air inlet 11. Not only does it enable an appearance of the casing 1 to be more complete, but it also improves a heat dissipation of the motor 3, while also giving the operator a better experience.

The above embodiments are only used to illustrate technical solutions of the disclosure rather than to limit it. Although the disclosure is described in detail with reference to the preferred embodiments, ordinary technicians in this field should understand that the technical solutions of the disclosure may be modified or replaced by equivalents without departing from a spirit and a scope of the technical solutions of the disclosure.

What is claimed is:

1. A string trimmer, comprising:
a casing,
a battery pack assembled on the casing,
a motor accommodated in the casing,
a volute structure assembled in the casing, and
a metal dust-proof net mounted on the casing,
the volute structure defining a cavity and an air outlet communicating the cavity with an outside, the motor partially accommodated in the cavity, the air outlet located at a top of the volute structure and is positioned facing a side wall of the casing, a bottom of the casing provided with an air inlet, and the metal dust-proof net mounted at the air inlet.

2. The string trimmer according to claim 1, wherein, an annular volute passage is arranged in the cavity, the volute passage is communicated with the air outlet, the motor is provided with a fan blade, the fan blade is accommodated in the cavity, and the volute passage is arranged around the fan blade.

3. The string trimmer according to claim 2, wherein, the motor is provided with an air inlet hole, the air inlet hole is communicated with the air inlet and the volute passage, so that external airflow enters from the air inlet, passes through the motor via the air inlet hole, enters the volute passage, and then flows out from the air outlet.

4. The string trimmer according to claim 1, wherein, the volute structure comprises a first housing and a second housing assembled with each other, the first housing is provided with a protruding part, the protruding part is fixedly connected with the casing, the protruding part is provided with a holding space, and the motor passes through the second housing and enables a motor shaft of the motor to extend into the holding space and to be connected with the protruding part.

5. The string trimmer according to claim 4, wherein, the first housing and the second housing are assembled with each other through a buckle and a concentric hole.

6. The string trimmer according to claim 1, wherein, the casing comprises an upper casing and a lower casing, a recess is arranged on a side wall of the lower casing, the volute structure extends to the recess and enables the air outlet to be located above the recess, and the upper casing covers the air outlet.

7. The string trimmer according to claim 1, wherein, the metal dust-proof net comprises a frame and a filter net flatly arranged on the frame, the frame is mounted on the casing through a hook and a fastener, and the filter net is limited between the frame and the air inlet.

8. The string trimmer according to claim 1, wherein, a mounting groove is arranged on one side of the casing, and the battery pack is detachably inserted into the mounting groove.

9. The string trimmer according to claim 8, wherein, a guiding rail is arranged on an inner wall of the mounting groove, and a guiding groove is arranged on an outer wall of the battery pack, and the guiding rail and the guiding groove are matched with each other to guide the battery pack to be inserted into the mounting groove.

10. The string trimmer according to claim 8, wherein, the casing is provided with an opening, the opening is communicated with the mounting groove to enable the battery pack to be partially exposed.
